(19) United States
(12) Patent Application Publication
(10) Pub. No.: US 2025/0214598 A1
(43) Pub. Date: Jul. 3, 2025

(54) MAP DOWNLOAD AND STORAGE MANAGEMENT FOR AUTONOMOUS SYSTEMS AND APPLICATIONS

(71) Applicant: NVIDIA Corporation, Santa Clara, CA (US)

(72) Inventors: Russell CHREPTYK, Seattle, WA (US); Jeffrey LIU, Bellevue, WA (US); Michael KRON, Redmond, WA (US); Amir AKBARZADEH, ALAMO, CA (US); Vaibhav THUKRAL, Bellevue, WA (US)

(21) Appl. No.: 18/403,536

(22) Filed: Jan. 3, 2024

(51) Int. Cl. B60W 50/06; B60W 60/00; G06F 9/48; G06F 16/29

(52) U.S. Cl. CPC B60W 50/06; B60W 60/001; G06F 9/4881; G06F 16/29; B60W 2556/40; B60W 2556/45

(57) ABSTRACT

The present disclosure relates to intelligent download and management of map data. For example, a machine may use map data stored thereon to perform operations. The map data may be organized according to multiple data layers based at least on different types of map data used by multiple different processes of a processing system of a machine. The different processes may be configured to perform one or more operations associated with a navigation system. A computing system may be configured to cause communication of one or more individual data layers to the processing system based at least on one or more individual prioritizations associated with the one or more individual data layers. The individual prioritizations may be based at least on a timing of processing of the individual data layers by one or more processes that are respectively associated with the individual data layers.

### BACKGROUND

In some instances, a map of an area may include a visual or encoded representation of geographic information of layouts and features of the area. The map may be generated based on corresponding map data that may include underlying geographic information that is used to create the map. For example, the map data may include information about locations, poses, sizes, orientations, spatial relationships, and attributes of and among geographic objects and/or features. For example, the map data may include data that corresponds to, by way of example and not limitation, roads, road signs, buildings, art locations, parks, traffic lights, static objects, barricades, lane lines, road boundaries, road lines (e.g., cross-walk lines, bike lanes, etc.), and/or other features and/or objects.

Some approaches to generating the map may include loading and/or downloading the map data as a machine travels through an area. In some instances, a system may include a data storage storing the map data—such as map data corresponding to a specific map stored thereon. A machine and/or a navigation system of the machine may request the map data corresponding to the specific map from the data storage. For instance, the machine may request and/or obtain the map data to be implemented with the navigation system of the machine to generate the map. As the map data is obtained actively while the machine is traveling, downloading may be interrupted in instances where a communication between the system and the data storage is affected (e.g., disruption in and/or loss of cellular network, increased traffic, etc.).

Some other approaches to generating the map may include loading and/or downloading the map data in bulk for a substantial portion of a travel route of the machine. For instance, the travel route may be predetermined for the machine. The navigation system of the machine may obtain the map data corresponding to areas covered by the travel route from the data storage. By pre-downloading the map data, the navigation system may generate the map and/or provide directions to the machine for the travel route without interruption. However, such an approach may not be as effective in situations where the machine travels off of the initial travel route. Furthermore, such an approach may require loading and/or downloading unnecessary portions of the map data.

### SUMMARY

Systems and methods are presented for managing map data downloading and storage for autonomous or semi-autonomous systems and applications. According to one or more embodiments of the present disclosure, a data storage may have map data corresponding to a map stored thereon. The map data may be organized according to multiple data layers based at least on different types of map data used by multiple different processes of a navigation, planning, control, and/or other system of a machine. A computing system may be configured to cause communication of one or more individual data layers to the processing system based at least on one or more individual prioritizations associated with the one or more individual data layers. The individual prioritizations may be based at least on a timing of processing of the individual data layers by one or more processes that are respectively associated with the individual data layers.

The embodiments of the present disclosure may help organize map data into different data layers corresponding to different data types in a manner that may increase efficiency and decrease an amount of memory used to access the map data. For example, the different data layers of the map data corresponding to different areas may be communicated to different processes of the machine. Additionally or alternatively, the data layers may be communicated to the processes at different times based on different priorities assigned to the processes. Some traditional approaches to organizing map data may include dividing the map data into different layers. In some traditional approaches, the map data divided into different layers may be downloaded together as a group which may consume increased memory and/or constant network connectivity.

The embodiments of the present disclosure may load and/or download the map data more efficiently than other traditional approaches. For example, one or more embodiments of the present disclosure may allow for different data layers to be loaded and/or downloaded at different times and/or in different orders to improve efficiency of data use and to decrease a risk of losing map coverage while traveling due to disrupted or lost network connectivity.

### BRIEF DESCRIPTION OF THE DRAWINGS

The present systems and methods for map data download and storage management for autonomous or semi-autonomous systems are described in detail below with reference to the attached figured, wherein:

FIG. 1 illustrates an example system configured to determine navigational operations for a machine, in accordance with one or more embodiment of the present disclosure;

FIG. 2A illustrates an example map that may be divided into one or more tiles and/or one or more segments, in accordance with one or more embodiments of the present disclosure;

FIG. 2B illustrates example tile data corresponding to a tile, in accordance with one or more embodiments of the present disclosure;

FIG. 3 illustrates a flow diagram showing a method of causing one or more navigational operations to be performed based at least on data layers represented by map data, in accordance with one or more embodiments of the present disclosure;

FIG. 4A is an illustration of an example autonomous vehicle, in accordance with one or more embodiments of the present disclosure;

FIG. 4B is an example of camera locations and fields of view for the example autonomous vehicle of FIG. 4A, in accordance with one or more embodiments of the present disclosure;

FIG. 4C is a block diagram of an example system architecture for the example autonomous vehicle of FIG. 4A, in accordance with one or more embodiments of the present disclosure;

FIG. 4D is a system diagram for communication between cloud-based server(s) and the example autonomous vehicle of FIG. 4A, in accordance with one or more embodiments of the present disclosure;

FIG. 5 is a block diagram of an example computing device suitable for use in implementing one or more embodiments of the present disclosure; and

FIG. 6 is a block diagram of an example data center suitable for use in implementing one or more embodiments of the present disclosure.

### DETAILED DESCRIPTION

Systems and methods of the present disclosure correspond to map data download and management for autonomous or semi-autonomous systems and applications. One or more embodiments of the present disclosure may relate to organizing map data into one or more data layers based at least on different types of map data. In some embodiments, the one or more data layers may correspond to one or more subsets of the map data. For instance, the data layers may include corresponding layer data that includes sets of information about a setting represented by a map. For example, the data layers may include a routes layer (e.g., including map data related to transportation routes such as roads, highways, railways, walking paths, etc.), a lanes layer (e.g., traffic lanes on roads, streets, and/or highways), an elevation layer (e.g., elevation and/or topography of terrain), a water bodies layer (e.g., location, shape, size, and/or depth of water bodies), a land use layer (e.g., types of land use or land cover), a road signs layer (e.g., information and/or location of road signs such as traffic signs and speed limits), a traffic-signals layer (e.g., location, color, status of traffic signals), a vegetation layer (e.g., distribution, types, and/or characteristics of vegetation or plant cover), a transportation layer (e.g., transportation infrastructure), a satellite imagery layer (e.g., satellite imagery of the Earth's surface including, buildings, road, etc.), a local image layer (e.g., images of different parts of an area taken using one or more cameras), a local RADAR layer (e.g., information regarding structures, roads, vehicles, machines, animals, and/or humans obtained using RADAR, which may be used for localization RADAR), a LiDAR layer, an ultrasonic layer, a wait condition layer, and/or other layer types.

In some embodiments, the data layers may be organized such that the data layers correspond to different processes of a navigation system of a machine. For instance, the data layers may be used by different processes of the navigation system of the machine to perform one or more navigational operations. In some embodiments, the different processes of the navigation system may be configured to use different types of data. For example, the navigation system may include one or more processes corresponding to different data layers. For example, in some embodiments, the processes may include route determination, lane determination, localization, among others.

In some embodiments, processes of the navigation system may obtain different data layers at different times with respect to a corresponding area. For instance, a first process configured for route determination may obtain or reference the routes layer of the map data for an entire travel route as the machine begins traveling. Contrastingly, a second process configured for lane determination may obtain or reference the lanes layer as the machine travels closer to relevant lanes.

In some instances, the data layers may have varying sizes. For instance, the sizes of the data layers may vary based at least on the type of data included in the data layers. In some embodiments, different types of data may include different levels of detail, spatial resolutions, data formats, complexity, etc. which may lead to different sizes. In general, more details, higher resolutions, and uncompressed data formats may lead to larger data layer sizes. For example, a size of the routes layer may be comparatively smaller than the lanes layer. For instance, the routes layer may include a lower number of details and a lower resolution compared to the lanes layer. For example, the routes layer may use data related to how roads are placed and/or laid out. The routes layer may include data with relatively low resolution. For instance, the routes layer may not include higher level information on road lanes (e.g., a left lane, a middle lane, a right lane) to determine the route. Contrastingly, the lanes layer may include additional data related to the roads (e.g., locations of lane boundaries, road boundaries, lane rails, lane curvature, etc.). The added detail may cause the size of the lanes layer to be larger than the routes layer.

In some embodiments, the data layers loaded and/or downloaded further ahead along the travel route (e.g., covering more geographical area) may include relatively smaller sizes. For instance, the routes layer may be relatively smaller which may not be as burdensome to load and/or download ahead of time for the entire travel route. Further, by loading and/or downloading the data layers with relatively larger sizes as the machine moves closer to the geographical area, a risk of loading and/or downloading unnecessary map data may be reduced. For instance, even if the machine travels off a planned and/or predetermined travel route, only the map data corresponding to smaller data layers (e.g., the routes layer) are wasted (e.g., loaded but not used), instead of wasting an entire set of data layers that include larger data layers (e.g., the local image layer and the local RADAR layer).

One or more embodiments of the present disclosure may help improve efficiency and/or reliability over some traditional approaches of navigational, planning, localization, and/or other systems. For example, some traditional approaches may include obtaining map data corresponding to an area at once. For instance, some traditional approaches may include obtaining an entire set of map data corresponding to a predetermined travel route of a machine ahead of time. However, such an approach may become inefficient and more burdensome for a system as the travel route becomes longer and/or more complicated. For instance, size of the map data to be loaded and/or downloaded at once may place more burden on a memory and/or may increase processing times. Additionally or alternatively, such an approach may cause unnecessary map data to be loaded and/or downloaded. For instance, an increased amount of map data, including unnecessary map data for a particular operation(s) and/or region, may be loaded and/or downloaded. In some embodiments, the unnecessary map data may refer to map data that is ultimately unused. For instance, the machine may travel off the predetermined travel route which may require additional map data for a new route and the map data corresponding untraveled portion of the predetermined route may be unused or wasted.

Additionally or alternatively, in some traditional approaches, reliability (e.g., constantly obtaining map data relevant to the travel route) may be affected. For instance, some traditional approaches may include obtaining the map data corresponding to the machine's surroundings as the machine travels. For example, map data corresponding to a certain area around the machine may be obtained as the machine travels. Such an approach may be more efficient than loading and/or downloading the map data for the entire travel route as map data may be obtained for specific areas around the machine even when the machine travels off the predetermined route. However, such an approach may not be reliable in instances without constant network connectivity. For instance, the navigation system of the machine may be configured to obtain the map data from a data storage over a network—such as a cellular network. As the machine travels through areas with weak and/or no cellular network, the map data may not be obtained.

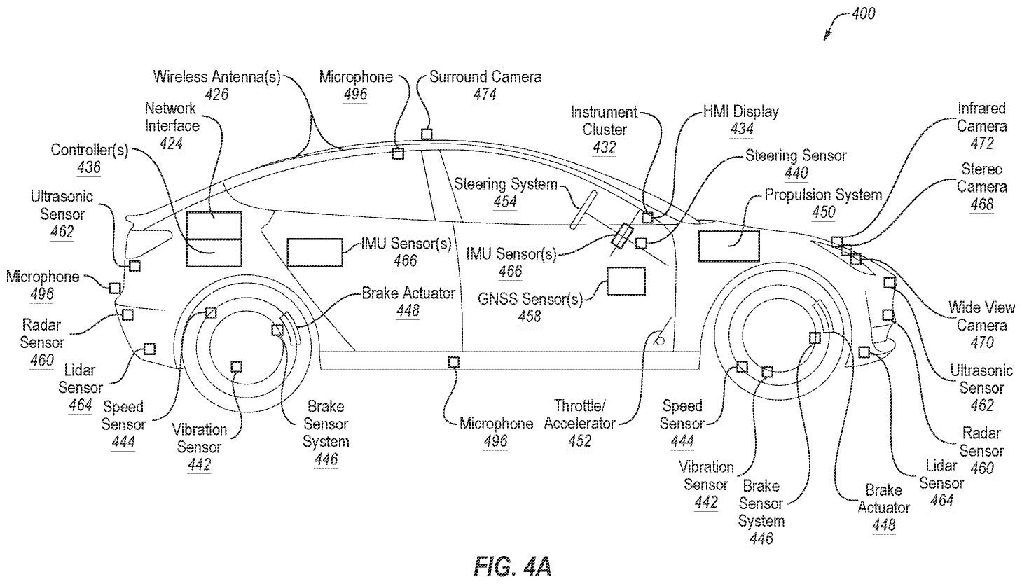

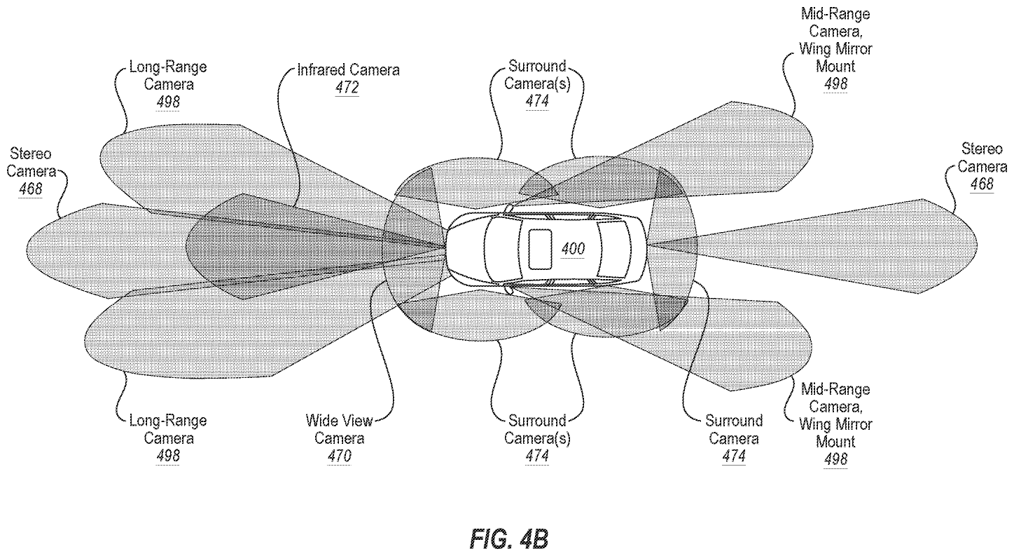

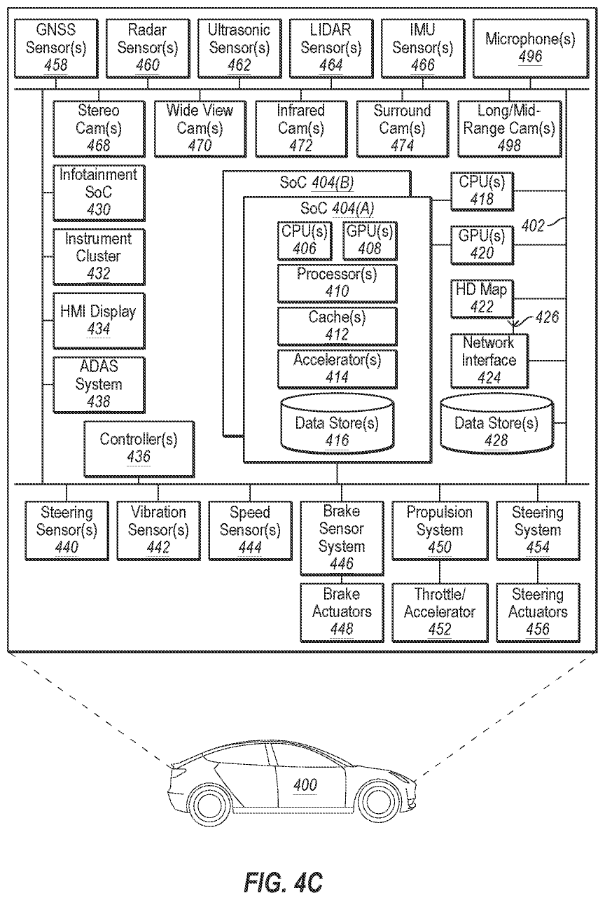

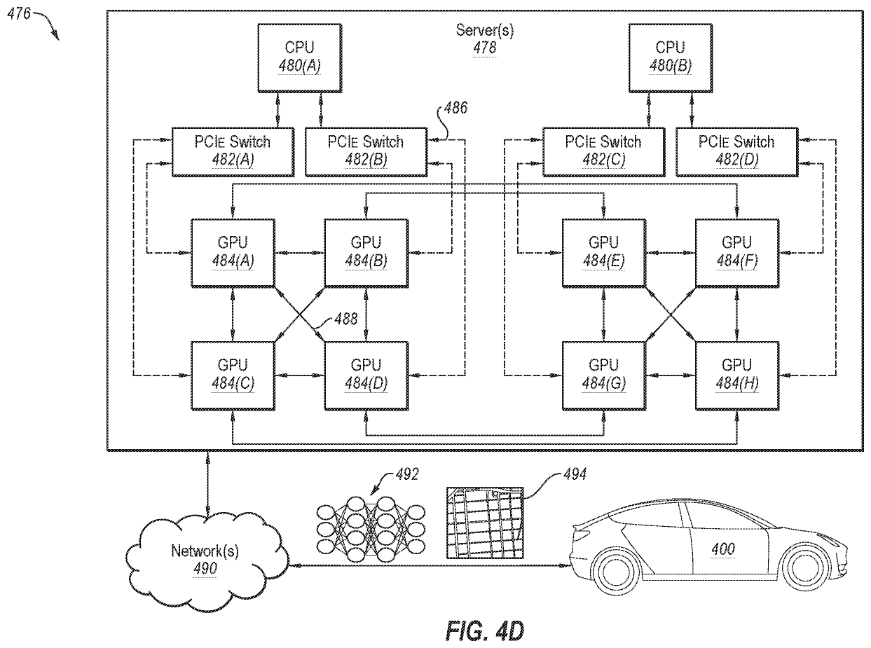

One or more of the embodiments disclosed herein may be related to obtaining map data organized in data layers corresponding to a travel route of one or more ego-machines and/or components of the one or more ego-machines, which may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 400 (alternatively referred to herein as “vehicle 400” or “ego-machine 400”) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI, data center processing, conversational AI (such as by employing one or more language models such as one or more large language models (LLMs)), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations (e.g., systems that implement one or more language models, such as large language models (LLMs)), systems for performing one or more generative AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

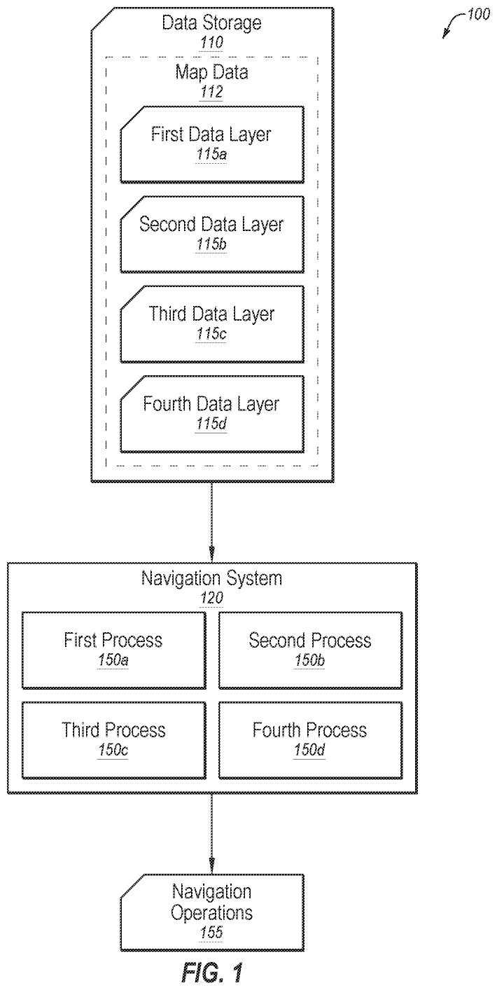

With respect to FIG. 1, FIG. 1 illustrates an example system 100 configured to determine navigational operations for a machine, in accordance with one or more embodiment of the present disclosure. In some embodiments, the system 100 may be implemented with respect to a machine. For example, the system 100 may be implemented with respect to vehicle 400 of FIGS. 4A-4D. For instance, the system 100 may be configured to determine navigational operations of the vehicle 400.

As detailed herein, in general, the system 100 may include a data storage 110 and a navigation system 120. In some embodiments, the data storage 110 may include a computing device configured to initiate communication between the data storage 110 and the navigation system 120.

In some embodiments, the data storage 110 may be configured to store map data 112. For example, the data storage 110 may be configured to store the map data 112 corresponding to a specific map stored thereon. In some embodiments, the data storage 110 may include any physical hardware devices that may be used to store digital information. For example, the data storage 110 may include hard disk drives (HDDs), solid-state drives (SDDs) optical discs, flash drives, network attached storage (NAS), buffers, caches, and/or other storage or memory devices. In some embodiments, the data storage 110 may be cloud based. For instance, the map data 112 may be stored on a cloud server.

In some embodiments, the data storage 110 may store the map data 112 in different formats suitable for the map data 112. For example, the map data 112 may be in shapefile format, GeoJSON format, GeoTIFF format, NetCDF format, and/or any other suitable data formats.

In some embodiments, the map data 112 stored in the data storage 110 may be organized according to data layers. For example, the map data 112 may be organized into a first data layer 115a, a second data layer 115b, a third data layer 115c, and a fourth data layer 115d. In some embodiments, the first data layer 115a, the second data layer 115b, the third data layer 115c, and the fourth data layer 115d may be collectively referred to as data layers 115. While FIG. 1 illustrates the data layers 115 as having four data layers, the data storage 110 may include any suitable number of data layers. In these and other embodiments, the data layers 115 may correspond to one or more subsets of the map data 112 representing different types of the map data 112.

For instance, the data layers 115 may include subsets of data that may be used for different functions or purposes, and/or that include different data formats. For example, the data layers 115 may include a routes layer (e.g., including map data related to transportation routes such as roads, highways, railways, walking paths, etc.), a lanes layer (e.g., traffic lanes on roads, streets, and/or highways), an elevation layer (e.g., elevation and/or topography of terrain), a water bodies layer (e.g., location, shape, size, and/or depth of water bodies), a land use layer (e.g., types of land use or land cover), a road signs layer (e.g., information and/or location of road signs such as traffic signs and speed limits), a traffic-signals layer (e.g., location, color, status of traffic signals), a vegetation layer (e.g., distribution, types, and/or characteristics of vegetation or plant cover), a transportation layer (e.g., transportation infrastructure), a satellite imagery layer (e.g., satellite imagery of the Earth's surface including, buildings, road, etc.), a local image layer (e.g., images of different parts of an area taken using one or more cameras), a local RADAR layer (e.g., information regarding structures, roads, vehicles, machines, animals, and/or humans obtained using RADAR), a LiDAR layer, an ultrasonic layer, a wait conditions layer, and/or other layers.

For the purposes of some examples described in the present disclosure, the first data layer 115a may correspond to the routes layers, the second data layer 115b may correspond to the lanes layer, the third data layer 115c may correspond to the local image layer, and the fourth data layer 115d may correspond to the local RADAR layer. In the present disclosure, a reference to the first data layer 115a, the second data layer 115b, the third data layer 115c, and the fourth data layer 115d may include a reference to the routes layer, the lanes layer, the local image layer, and the local RADAR layer, respectively.

In some embodiments, the map data 112 may be used by the navigation system 120 (alternatively referred to or implement as a planning system, control system, autonomous or semi-autonomous driving system) to determine one or more navigation operations 155 for a machine and/or a system such as an ego-machine. For instance, the navigation system 120 may request the map data 112 corresponding to specific areas from the data storage 110. The navigation system 120 may determine the navigation operations 155 such as, route planning, map reading, GPS navigation, landmark recognition, lane switching, wayfinding, localization, among others, based at least on the map data 112. In some instances, the navigation system 120 may cause the machine to perform operations based at least on the navigation operations 155 determined by the navigation system 120. In some embodiments, the navigation system 120 may be a component (e.g., software, firmware, and/or hardware) of the machine.

In some embodiments, the navigation system 120 may include one or more processes 150 that may be configured to determine the navigation (or planning, or control, or localization) operations 155. For instance, the processes 150 may include one or more algorithms and/or operations that may be configured to obtain the map data 112 from the data storage 110 and process the map data 112 to determine the navigation operations 155. In some embodiments, the processes 150 may include separate processes configured to perform different operations with respect to the map data 112. For instance, the processes 150 may be configured to determine different navigation operations 155. For example, individual processes of the processes 150 may perform operations for route planning, map reading, GPS navigation, landmark recognition, lane switching, wayfinding, localization, among others. In these and other embodiments, the processes 150 may be configured to use specific types of map data 112 to determine the different navigation operations 155. For instance, the processes 150 may be configured to use one or more data layers 115.

In some embodiments, the navigation system 120 may include a first process 150a, a second process 150b, a third process 150c, and a fourth process 150d. Although illustrated as having four processes, the navigation system 120 may include any suitable number of processes. For instance, the navigation system 120 may include a smaller number of processes or a greater number of processes. Additionally or alternatively, multiple processes may be combined into fewer numbers of processes configured to perform different types of functions. In some embodiments, the number of processes may correspond to number of the data layers 115 stored in the data storage 110. In other embodiments, the number of processes may be fewer than the number of data layers. In the present disclosure, the first process 150a, the second process 150b, the third process 150c, and the fourth process 150d may be collectively referred to as the processes 150. In these and other embodiments, the data layers 115 may be used by individual processes of the navigation system 120 to build at least a portion of a map to be used by the navigation system 120 and/or to cause specific navigation operations.

For example, the first process 150a may be configured to determine the travel route for the machine between a starting point and a destination. For instance, the first process 150a may include one or more routing algorithms that may calculate the travel route based on one or more parameters. In these and other embodiments, the parameters may include distance, time, traffic, turn restrictions, historical routes, user preferences, among others. The first process 150a may obtain the starting point, the destination, corresponding map data and determine the travel route based at least on the parameters. In some embodiments, the corresponding map data 112 may include a corresponding data layer 115 of the map data 112.

For example, the first process 150a may be configured to receive the first data layer 115a (e.g., the routes layer) to determine the travel route. For instance, the first process 150a may be configured to process the map data 112 related to roads, highways, railways, walking paths, transit routes, traffic data, and other map data 112 related to routes to determine the travel route. In some embodiments, the first data layer 115a may include such map data 112 related to roads. In these and other embodiments, the first process 150a may be configured obtain the map data 112 corresponding to the first data layer 115a and not obtain other data layers of the map data 112 to determine the travel route, which may allow for faster processing compared to receiving and/or parsing through map data 112 that may not be pertinent to the first process 150a.

In some embodiments, the first process 150a may identify and fetch the first data layer 115a among the data layers 115 based on tags associated with the data layers 115. For instance, the data layers 115 may be tagged as corresponding to certain processes 150 based on types of data included in the data layers 115. For example, the first data layer 115a may be tagged as corresponding to the first process 150a, based at least on the type of data of the first data layer 115a. In some instances, the data layers 115 may be tagged based at least on requests from the processes 150. For example, the first process 150a may request certain types of data (e.g., the roads data) from the data storage 110. In response to such a request, the data storage may locate the corresponding data layer (e.g., the first data layer 115a), provide the requested data to the first process 150a, and tag the first data layer 115a to be associated with the first process 150a for future uses.

Additionally or alternatively, the first process 150a may request and fetch the first data layer 115a based at least on metadata corresponding to the first data layer 115a. For instance, the data layers 115 may include corresponding metadata representing the types of data included in the data layers 115. For example, the metadata may include information about the data included in the data layers 115 such as title, description, data source, data format, data structure, keywords, categories, version history, among others. In some embodiments, the metadata may also include information about related data layers from the data layers 115. For instance, in some embodiments, the map data 112 related to roads and/or routes may be divided into one or more data layers. For example, the first data layer 115a may include the map data 112 about different roads and paths while another data layer may include the map data 112 corresponding to the traffic data which the first process 150a may use. In these instances, by analyzing the metadata of the first data layer 115a, the first process 150a may fetch the first data layer 115a as well as the data layer including the traffic data. In these and other embodiments, the first process 150a may inspect the metadata of other data layers in the data layers 115 and disregard the other data layers as unnecessary for the first process 150a.

As another example, the second process 150b may be configured to determine lanes (e.g., traffic lanes) for the machine as the machine is traveling on the travel route, such as the travel route determined by the first process 150a. In these and other embodiments, the second process 150b may be configured to determine lanes for the machine to traverse. In some embodiments, the determined lanes may allow the machine to travel over the travel route more efficiently and/or safely. For example, the second process 150b may allow the machine to switch lanes ahead of time to reduce any risks that may be associated with last-minute lane changes. For instance, the machine may be coming up to a left turn a certain distance away. The second process 150b may determine and provide to the machine that two far-left lanes are designated for left turns. The second process 150b may determine a navigation operation that causes the machine to change lanes ahead of time to make the left turn.

In these and other embodiments, the second process 150b may be configured to request and fetch one or more data layers including the map data 112 corresponding to the operations of the second process 150b. For instance, the second process 150b may request the one or more data layers including the map data 112 related to traffic lanes from the data storage 110. In these and other embodiments, the second data layer 115b may be identified based at least on the tags associated with the second data layer 115b and/or the metadata related to the second data layer 115b.

Yet another example, the third process 150c may be configured to perform localization of the machine. For instance, the third process 150c may be configured to determine a position and/or a location of the machine in context of a geographic area. For instance, the third process 150c may determine the location of the machine relative to different landmarks, other vehicles, and/or other objects in surrounding environment. In some embodiments, the third process 150c may perform localization based at least on image data of local surroundings of the machine. For example, the image data may be obtained using one or more cameras. In these and other embodiments, the image data may be contained in a specific data layer of the map data 112.

In some embodiments, the third process 150c may request and fetch, from the data storage 110, one or more data layers with tags corresponding to the localization. For instance, the third process 150c may fetch one or more data layers tagged for localization. In some embodiments, the data layers 115 with information related to localization such as local image data may be tagged for localization. For example, the third data layer 115c may include the image data for the third process 150c to perform localization. In such instances, the third process 150c may obtain the third data layer 115c to perform localization.

Additionally or alternatively, the third process 150c may perform localization using RADAR data. For instance, the RADAR data may be obtained using one or more sensors. For example, one or more RADAR signals may be transmitted by the one or more sensors. The RADAR signals may reflect on objects in the environment to generate RADAR echoes. The one or more sensors may receive the RADAR echoes to determine the location of the objects as well as the machine in context of the geographic area. In these and other embodiments, the third process 150c may obtain the fourth data layer 115d, which may also be tagged for localization and/or include metadata that represent data related to localization. In some embodiments, the third process 150c may identify the fourth data layer 115d based at least on the metadata corresponding to the third data layer 115c. For instance, the third data layer 115c may include a metadata representing related data layers which may include the fourth data layer 115d.

In some embodiments, one or more processes 150 may be configured to perform parts of the localization operations. For instance, the third process 150c and the fourth process 150d may both be configured to perform localization. However, the third process 150c and the fourth process 150d may be configured to perform localization using different types of data. For example, the third process 150c may use the local image data while the fourth process 150d may use the local RADAR data. In these and other embodiments, the third process 150c and the fourth process 150d may identify and obtain the third data layer 115c and the fourth data layer 115d, respectively, based at least on the metadata associated with the data layers 115.

In some embodiments, the map data 112 obtained by the navigation system 120 of the machine may include different data layers spanning and/or covering different geographical areas. For instance, the navigation system 120 may obtain different amount of layer data for the data layers being obtained. For example, the navigation system 120 may obtain, for use by the first process 150a, the routes layer of the map data 112 spanning entire travel route between the starting point and the destination simultaneously. For instance, to determine a particular travel route between the starting point and the destination, the first process 150a may use corresponding map data 112 for the entire travel route (e.g., the map data 112 used to determine the travel route). In these and other embodiments, the first data layer 115a may be obtained prior to or at the beginning of travel.

In some embodiments, the navigation system 120 may obtain, by the second process 150b, the map data 112 corresponding to the second data layer 115b (e.g., the lanes layer) for a smaller geographical area at a time compared to the first data layer 115a. For instance, the second process 150b may obtain the second data layer 115b for an area within a certain distance from the machine rather than the entire travel route. For example, the navigation system 120 may obtain the second data layer 115b for a specific range of area ahead of the machine (e.g., 2 km ahead of the machine). In some instances, the specific distance may be specified by the user. For example, the user may input how far ahead the user may prefer to obtain information regarding switching and/or staying in different lanes. Additionally or alternatively, the navigation system 120 may determine the specific range. For instance, the navigation system 120 may determine the specific range based at least on speed of the machine's movement, complexity of the travel route, and other parameters that may affect the machine's travel.

In some embodiments, the specific range may be based at least on amount of the second data layer 115b that the second process 150b is processing at a given instance. For instance, the second process 150b may be configured to process the map data 112 (e.g., portion included in the second data layer 115b) corresponding to a certain range of the navigation system and/or the machine. For example, the second process 150b may be configured to process the map data 112 for an area 2 km ahead of the vehicle. In these instances, the second process 150b may be configured to obtain the map data 112 in the second data layer 115b in portions corresponding to 2 km areas.

In some embodiments, the navigation system 120 may obtain, by the third process 150c and/or the fourth process 150d, the map data 112 corresponding to the third data layer 115c (e.g., the local image layer) and/or the fourth data layer 115d (e.g., the local RADAR layer) for a relatively small geographical area (e.g., compared to the first data layer 115a and/or the second data layer 115b) at a time. For instance, the third process 150c and/or the fourth process 150d may obtain the third data layer 115c and/or the fourth data layer 115d for an area within certain radius of the machine.

In some instances, the certain radius may be determined based at least on amount of the map data 112 for localization. The amount may vary based on one or more factors such as environmental complexity, sensor types, localization method, redundancy and robustness, historical data, among others. For instance, the third process 150c and/or the fourth process 150d may be configured to obtain the corresponding map data 112 for a larger area in situations where the third process 150c and/or the fourth process 150d may take longer to process. For example, the third process 150c and/or the fourth process 150d may take longer to process the third data layer 115c than the fourth data layer 115d due to the image data being more complex than the RADAR data which may cause the third data layer 115c to be obtained earlier and/or for a larger geographical area. As an example, the navigation system 120 may obtain the map data 112 corresponding to the third data layer 115c for an area within 200-meter radius around the machine. Additionally, the navigation system 120 may obtain the map data 112 corresponding to the fourth data layer 115d for a smaller area of within a 50-meter radius around the machine.

In some embodiments, the different sizes and/or the areas covered by the data layers 115 that are downloaded and/or loaded at once may correspond to prioritizations assigned to the data layers 115. In these and other embodiments, the prioritizations may represent criticality and/or importance of the data layers 115. For instance, the data layers 115 with higher prioritization may be essential for the navigation system 120 to operate. For example, the navigation system 120 may not operate properly without determining the travel route, assigning a higher priority to the first data layer 115a. Contrastingly, the navigation system 120 may still operate without the localization functions, assigning a lower priority to the third data layer 115c and the fourth data layer 115d.

In some embodiments, the prioritizations may correspond to a data size of the layer data of the data layer being communicated to the navigation system 120. For instance, in some embodiments, the data layers with smaller layer data size may be assigned higher priorities. In these and other embodiments, the data layers with smaller layer data size may include the data layers with lower resolutions including foundational map data. For example, the first data layer 115a may include map data with lower resolutions and smaller data size accordingly. In such instances, the first data layer 115a may be given higher prioritization compared to the second data layer 115b that may include higher resolution data which may include larger data size.

In other embodiments, the data layers with larger data size may be assigned higher prioritization. For instance, the data layers with higher resolution such as the third data layer 115c and/or the fourth data layer 115d may be given higher prioritization compared to the first data layer 115a which may include smaller data size.

Additionally or alternatively, the data layers 115 may be assigned prioritizations based at least on how often and/or how far in advance the processes 150 are configured to perform operations with the data layers 115. For instance, the first process 150a may need to obtain and process the first data layer 115a further ahead (e.g., for the entire travel route) than how far ahead the second process 150b may need the second data layer 115b. For instance, determining the travel route may be prioritized over determining specific lanes over the travel route. In these and other embodiments, the first data layer 115a may be assigned a higher prioritization than the second data layer 115b, therefore obtained earlier than and/or for a larger area than the second data layer 115b.

Additionally or alternatively, the second data layer 115b may be prioritized over the third data layer 115c. For instance, determining the specific lanes by the second process 150b may be prioritized over the localization operations of the third process 150c. For example, the second process 150b may be configured to determine the specific lanes some time prior to reaching the lanes to provide the machine with time to switch the lanes. The third process may not perform localization and/or obtain the third data layer 115c and/or the fourth data layer 115d until the machine is in specific locations. In these and other embodiments, the second data layer 115b may be obtained earlier than and/or for a larger area than the third data layer 115c.

Modifications, additions, or omissions may be made to FIG. 1 without departing from the scope of the present disclosure. For example, the system 100 may include more or fewer elements than those illustrated and described in the present disclosure.

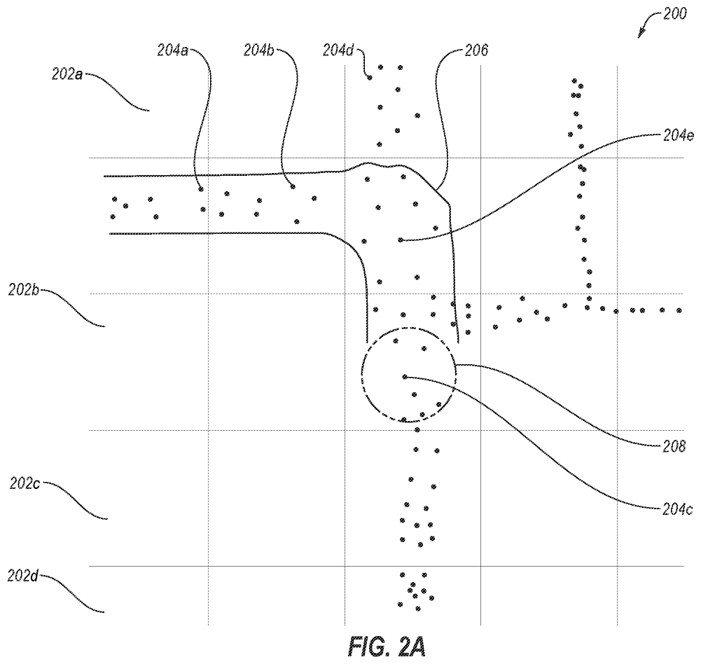

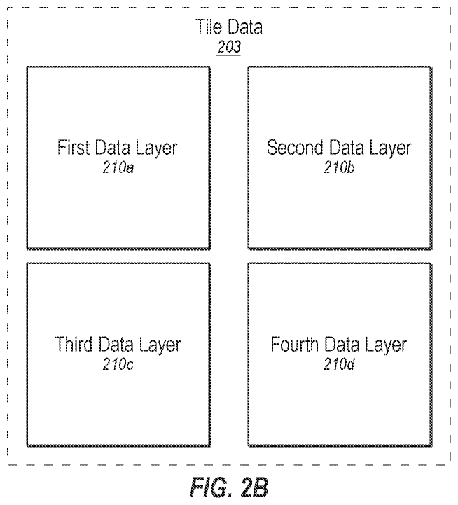

FIG. 2A illustrates an example map 200 that may be divided into one or more tiles and/or one or more segments, in accordance with one or more embodiments of the present disclosure. In some embodiments, the map 200 may correspond to an area in which a machine may be traveling.

In some embodiments, map data corresponding to the map 200 may be stored in a data storage (e.g., the data storage 110 of FIG. 1). In some embodiments, the map data in the data storage may be organized into one or more tile data sets that individually correspond to respective tiles of the map 200. For instance, the map 200 may be divided into one or more tiles that may represent certain geographical areas represented by the map 200. For example, the map 200 may be divided into a set of tiles 202 such as a first tile 202a, a second tile 202b, a third tile 202c, and a fourth tile 202d. In some embodiments, the map 200 may be divided into any suitable number of tiles to cover a geographical area covered by the map 200. In these and other embodiments, the map data may also be divided into one or more sets of tile data 203 (of FIG. 2B) that may respectively correspond to the tiles 202. The tile data 203 may accordingly represent the map data corresponding to a specific tile.

In some embodiments, the tiles 202 may include any suitable shapes to divide the map 200. For example, the tiles 202 may be shaped as a square, a rectangle, a polygon, among others. In some embodiments, the tiles 202 may be shaped and/or sized alike. For example, the map 200 may be divided into equally shaped and/or sized tiles 202. Additionally or alternatively, the tiles may be shaped and/or sized differently. For example, some tiles may be bigger (e.g., cover larger geographical area) than other tiles—e.g., tiles where the road network is more dense may be smaller whereas tiles for less dense road networks may be larger. In these and other embodiments, the tiles 202 may be shaped such that, when combined, an entire geographical area corresponding to the map 200 are covered by the tiles 202.

In some embodiments, the tile data 203 corresponding to the tiles 202 may be loaded and/or downloaded on an individual basis. For example, a navigation system (e.g., the navigation system 120 of FIG. 1) of a machine may obtain the map data corresponding to the map 200 on a tile-by-tile basis. For instance, the navigation system may obtain individual tile data corresponding to the tiles 202 that may be within relevant to the machine (e.g., within a travel route 206 of the machine) instead of obtaining the map data for entire map 200. For example, the second tile 202b may be relevant and/or covered by the travel route 206 while the first tile 202a, the third tile 202c, and the fourth tile 202d are not.

In some embodiments, the tile data 203 for the tiles 202 may be divided into data layers, such as described with respect to FIG. 1 of the present disclosure. For example, the tile data 203 may include a first data layer 210a, a second data layer 210b, a third data layer 210c, and a fourth data layer 210d (collectively referred to as the data layers 210). In these and other embodiments, the data layers 210 may be divided and/or grouped based at least on types of map data included in the data layers 210. In these instances, the navigation system may obtain particular data layers of the map data corresponding to the tiles 202 by different processes of the navigation system.

For example, a first process of the navigation system may be configured to obtain the tile data 203 corresponding to the first data layer 210a which may include the map data suitable for route matching and/or route determination. For instance, the first process may obtain the tile data 203 corresponding to the first data layer 210a for the tiles 202 that may be used to determine the travel route 206. For instance, the first process may obtain the first data layer 210a of the tile data 203 for the tiles 202 that may be relevant and/or include roads that may be included in the travel route 206. The first process may use the obtained map data to generate and/or determine the travel route 206. While the travel route 206 is illustrated as covering a portion of the entire travel route, the first process may determine the entire travel route between a starting point and a destination. Other data layers such as the second data layer 210b, the third data layer 210c, and the fourth data layer 210d may be obtained and/or used by other processes of the navigation system to determine various navigation operations.

In some embodiments, the tile data 203 may be further divided into one or more data segments that individually correspond to respective segments of respective tiles 202. A segment of a tile may refer to a sub-region and/or a part of the tile. In some embodiments, the segments may be represented using any suitable geometrical shapes. For example, the segments may be represented as squares or rectangles dividing up the tiles. In another example, the segments may include circular areas within the tiles. In yet another example, the segments may be represented using dots within the tiles. In such instances, an individual segment may cover a certain area around a corresponding dot. For instance, a particular segment may be represented as a dot pointing to a specific coordinate space (e.g., longitude and latitude) on the map 200. While represented as a dot, the particular segment may include a certain area within certain radius with the dot as a center point.

For example, the map 200 may include a first segment 204a, a second segment 204b, a third segment 204c, and a fourth segment 204d (collectively referred to as segments 204). The segments 204 may represent areas around the segments with a certain radius and/or a diameter. For example, the segments 204 may include a 40 meter-diameter area with the first segment 204a, the second segment 204b, the third segment 204c, and the fourth segment 204d as the center points.

In some embodiments, the diameter may be defined by a user. For instance, the user may define the diameter to be comparatively larger, which may allow the navigation system to obtain the map data corresponding to larger area at a time. In some instances, the user may define the diameter to be comparatively smaller, which may allow the navigation system to obtain the map data corresponding to the map 200 in smaller pieces.

In some embodiments, the tiles 202 may include predefined number of segments 204. For instance, individual tiles may include a same number of segments. In these and other embodiments, the segments 204 may be spread out evenly. For instance, the segments 204 may be spread out with substantially similar distance between the segments 204 within a tile. In other embodiments, the segments 204 may be spread out with varying distances between the segments 204 within the tile. In some embodiments, the distances may vary based at least on details and/or sizes of the map data in an area corresponding to the segments 204. For instance, certain areas may include larger sizes of map data corresponding to more details (e.g., crowded buildings, complex roads, high traffic, etc.) present in the area. In these instances, the segments 204 may be placed closer to reduce sizes of data segments corresponding to individual segments.

In some embodiments, the tiles 202 may include varying number of segments 204. For instance, the individual tiles covering areas with more details (e.g., crowded buildings, complex roads, high traffic, etc.) may include more segments 204 than other tiles with fewer details (e.g., simple roads, turns, no buildings, less buildings, etc.).

In some embodiments, the navigation system of the machine may be configured to download individual data segments corresponding to the segments 204 instead of downloading the entire tile data. For example, the individual data segments may include the data layers 210 corresponding to the individual segments. By breaking down the tile data further into data segments, less amount of data may be loaded and/or downloaded.

In some embodiments, the individual data segments to be loaded and/or downloaded may be determined using spatial data structures. For example, an R-Tree (Rectangular Tree) may be generated per tile which may allow users to look up location of the segments 204. For example, the R-Tree may include multiple bounding shapes (e.g., rectangles, squares, circles, other polygons, etc.) that divide the tiles 202. The bounding shapes may be shaped similarly or differently. Additionally, the bounding shapes may include multiple sub-shapes that make up the bounding shapes. In some embodiments, the bounding shapes may include one or more segments 204 within the tiles 202. In these and other embodiments, the bounding shapes may be used to record and/or keep track of locations of the segments 204. For instance, the segments 204 may be located using locations of the bounding shapes and/or the sub-shapes within the tile.

In some embodiments, the navigation system of the machine may download specific layers included in the individual data segments. For instance, the navigation system may determine the bounding shapes that are at least partially within a zone of interest of the machine. The navigation system may be configured to use the bounding shapes and/or the sub-shapes to determine specific map data (divided into data layers) corresponding to particular geographical location.

In these and other embodiments, the zone of interest of the machine may vary based at least on the different processes and/or applications of the system. For instance, the processes may be configured to execute one or more operations to determine varying navigation operations. In these and other embodiments, the processes may be configured to obtain map data corresponding to the processes for different areas. For instance, the processes may obtain the map data for areas with varying sizes and/or directions. In such instances, the zone of interest of the machine may be modified to correspond to a process that is obtaining the map data.

Additionally or alternatively, the zone of interest of the machine may vary for different data layers. For instance, the zone of interest for the first data layer 210a (e.g., a routes layer) may be determined using a channel-along-a-route approach. For example, the zone of interest may include areas along the travel route 206 that spans at a certain width. In some embodiments, the certain width may be determined based on field of view from the machine. For instance, the certain width may be determined such that the navigations system of the machine may have sufficient map data to determine navigation operations such as routes, turning, switching lanes, among others.

In some embodiments, the channel-along-a-route approach may be configured to cause the navigation system to obtain data segments along the travel route that fall within the certain width in advance. For instance, the navigation system may obtain the first data layer 210a of the tile data 203 corresponding to the segments 204 before reaching the segments 204. For example, the navigation system may obtain the data segments to determine the navigation operations in advance.

For example, the individual data segments corresponding to the routes layer for the segments within the particular bounding shape may be loaded and/or downloaded. For example, the first segment 204a and the second segment 204b may be located within the zone of interest along the travel route 206. In these instances, the first process of the navigation system may obtain the first data layer of the map data corresponding to the first segment 204a and the second segment 204b. Additionally or alternatively, the first process may obtain data segments corresponding to other segments within same bounding shapes and/or sub-shapes as the first segment 204a and the second segment 204b.

In some embodiments, a particular segment such as the third segment 204c may be outside of the travel route 206. In these instances, the map data corresponding to the third segment 204c may not be obtained by the first process of the navigation system. In some embodiments, the first process may obtain the data segments for all of the segments that fall within the zone of interest along the travel route 206 at a same time. For instance, the first process may obtain the data segments at a beginning of a travel session.

In some embodiments, the zone of interest for data layers such as a local image layer (e.g., the third data layer 210c) and/or a local RADAR layer (e.g., the fourth data layer 210d) may be determined following another approach different from the channel-along-a-route approach. For instance, the navigation system may be configured to obtain the map data included in the local image layer and the local RADAR layer in smaller bits as the machine is traveling. For example, the zone of interest may be determined using a radius-around-a-point approach. In such instances, an arbitrary circle 208 with a certain radius around the machine may be determined. In some embodiments, the arbitrary circle 208 may move along within the map 200 as the machine travels. For instance, the arbitrary circle 208 may retain the machine as a center point of the arbitrary circle 208. In these and other embodiments, as the machine is traveling along the travel route 206 and/or as the machine diverts from the travel route 206, the bounding shapes that fall within the zone of interest may be determined and the data segments corresponding to the local image layer and/or the local RADAR layer for the segments within the bounding shapes may be loaded and/or downloaded. For example, the third segment 204c may be located within the arbitrary circle 208 which may cause the navigation system to obtain the map data (for particular data layer) corresponding to the third segment 204c.

In these and other embodiments, a size of the arbitrary circle 208 may be specified by the user and/or the navigation system. While described as being a circle, any other suitable geometrical shapes may be used. In some embodiments, any other suitable spatial data structures may be used to determine the segments 204 that may be within the zone of interest. For example, a Quad-Tree may be used to organize and/or locate the segments 204.

In some embodiments, the map data may be downloaded by the navigation system associated with the machine while the machine is traveling. For instance, the map data may be downloaded from a remote data storage via wireless networks such as a cellular network. In some embodiments, the wireless networks may provide different level of connectivity based on different areas. For instance, certain areas along the travel route 206 may have weak or no connectivity to the cellular network such that downloading the map data may be impractical. In these and other embodiments, to compensate for such weak connectivity issues, the machine may pre-download the map data corresponding to an area ahead of the machine that the machine may be traveling toward may to reduce a chance of missing map data of an area due to connectivity.

In some embodiments, the navigation system may determine which areas along the travel route 206 may have weak or no network connectivity based at least on historical data. For example, the navigation system may keep track of and/or obtain records of reported connectivity issues for different areas in the map 200 (e.g., a heat map may be maintained, where historical network strength and connectivity are represented or encoded in the heat map). In other embodiments, the navigation system may determine which areas along the travel route 206 may have weak or no network connectivity based at least on metadata associated with the map data. For instance, the tile data 203 and/or the data segments may include the metadata representing connectivity strengths in areas corresponding to the tiles 202 and/or the segments 204.

In some embodiments, the area ahead of the machine subject to pre-downloading may be determined by one or more waypoints corresponding to a route. The one or more waypoints may include navigational reference points. For example, a waypoint may be a specific geographic location and/or a set of coordinates that may be used to define the travel route 206. After determining the one or more waypoints, map data corresponding to the one or more waypoints may be pre-downloaded. For example, the tiles 202 and/or the segments 204 associated with (e.g., within certain distance of and/or including the waypoints) may be located, and corresponding tile data and/or corresponding data segments may be obtained by the navigation system.

The travel route 206 and/or the waypoints may be determined based on one or more different approaches. For example, in some instances, the travel route 206 and/or the waypoints may be determined based on a committed route. The committed route may include a route that is selected by the user. For example, the user may specify a destination and choose which route may be taken to reach the destination. In some embodiments, the user may be provided with one or more recommended routes that the user may choose from. In these instances, the tile data 203 corresponding to the tiles along the committed route may be pre-downloaded. For example, the tile data 203 for the tiles 202 within a certain distance from the machine along the route may be downloaded. In some instances, the certain distance may be determined based on a tile queue. The tile queue may include a queue or a list of map tiles that are waiting to be loaded, rendered, and/or displayed. The tile queue may include a data structure and/or a mechanism configured to manage loading and rendering of the tile data in a sequential and/or a prioritized order. In some instances, the data segments corresponding to the segments 204 may be downloaded instead of tile data 203. For example, after determining the route and/or the waypoints, the radius-around-a-point approach and/or the channel-along-a-route approach may be used to determine the data segments to be downloaded.

In some embodiments, the travel route 206 may be determined based on a most probable path (MPP) approach. The most probable path may include an estimation of a path that the machine is likely to take based on multiple factors such as GPS data, traffic conditions, historical data, user preferences, real-time updates, alternate routes, among others. In some instances, the most probable path may be provided by the navigations system of the machine. For example, the machine may include a head unit implementing the navigation system. The head unit may determine the most probable path based at least on a starting point, a destination point, and the multiple factors listed above. In some instances, the route may deviate from the most probable path. For instance, the user may divert from the route and/or the navigation system may detect and/or determine a better route than the most probable path. In some embodiments, any other suitable route determination approaches may be used.

Modifications, additions, or omissions may be made to FIG. 2 without departing from the scope of the present disclosure. For example, the map 200 may include more or fewer elements than those illustrated and described in the present disclosure.

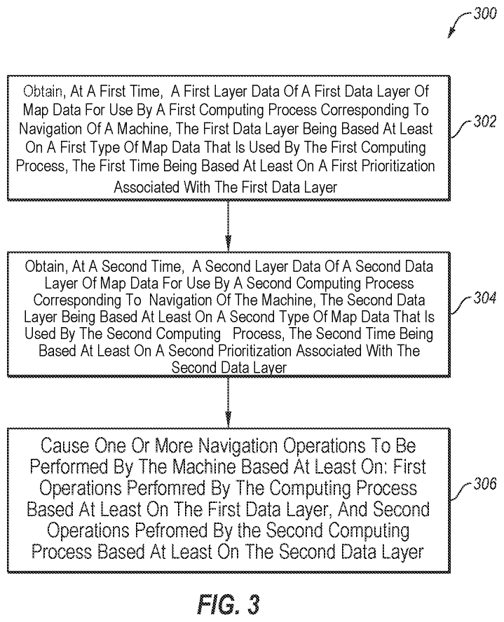

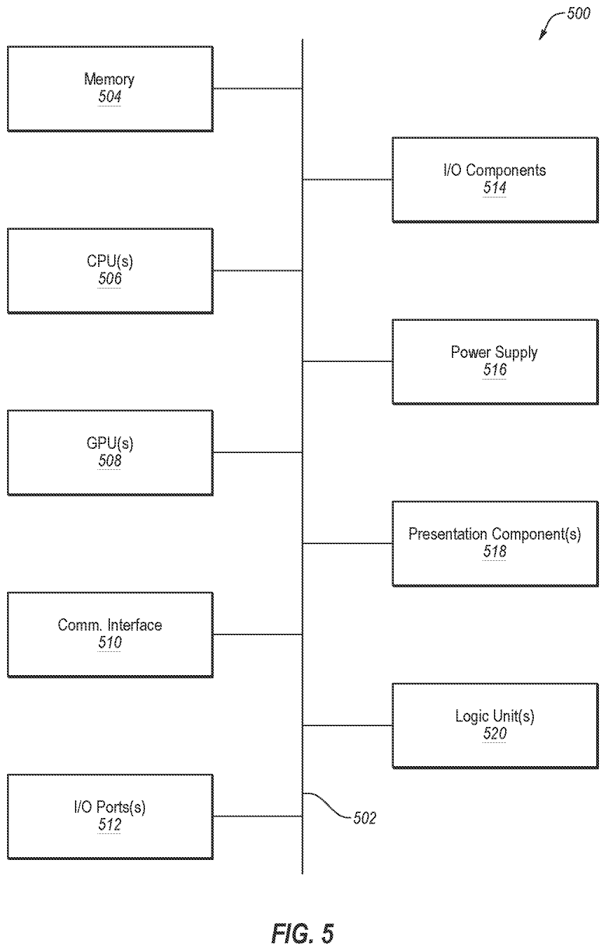

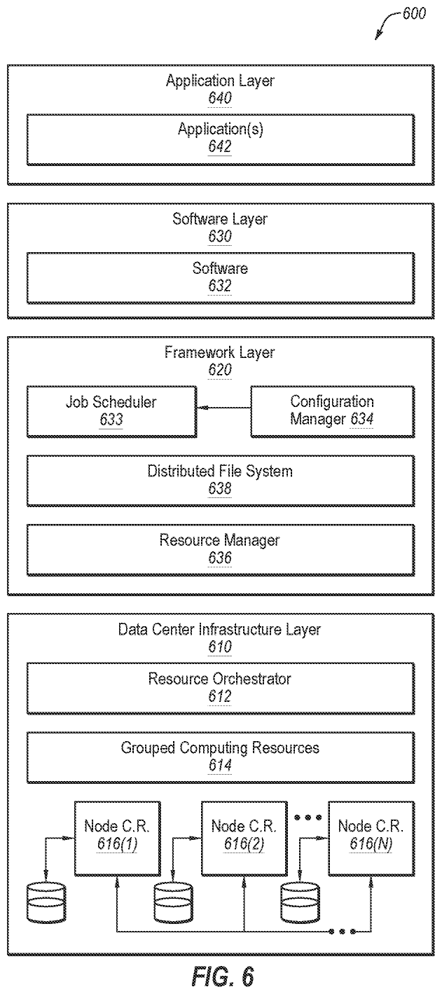

FIG. 3 is a flow diagram illustrating a method 300 for processing one or more data layers of map data, in accordance with one or more embodiments of the present disclosure. In some embodiments, one or more operations of the method 300 may be performed with respect to the system 100 of FIG. 1. One or more operations of the method 300 may be performed using any suitable system, apparatus, or device such as, for example, the system 100, the autonomous vehicle system(s) described with respect to FIGS. 4A-4D, computing device(s) described with respect to FIG. 5, and/or the data system(s) described with respect to FIG. 6 in the present disclosure.

The method 300 may include one or more blocks. Although illustrated with discrete blocks, the operations associated with one or more of the blocks of the method 300 may be divided into additional blocks, combined into fewer blocks, or eliminated, depending on the particular implementation.

In some embodiments, the method 300 may include block 302. At block 302, a first layer data of a first data layer of map data may be obtained at a first time. The first data layer of map data may be obtained for use by a first computing process corresponding to navigation of a machine. In some embodiments, the first time may be based at least on a first prioritization associated with the first data layer.

In some embodiments, the first data layer of map data may include a subset of the map data that may be used for different functions and/or purposes. For example, the first data layer may include the map data suitable for determination of routes and the first computing process may relate to route determination. In some embodiments, the first data layer may include a subset of the map data that may have certain data formats, such as described in the present disclosure for example with respect to the data layers 115 of FIG. 1.

In some embodiments, the first computing process may be configured to obtain the first data layer of map data for an area within a first zone of interest. The first zone of interest may be shaped and/or sized based at least on functions of the first computing process, such as described in the present disclosure for example with respect to FIG. 1.

At block 304, second layer data of a second data layer of the map data may be obtained at a second time. The second data layer of map data may be obtained for use by a second computing process corresponding to navigation of the machine. In some embodiments, the second data layer may be based at least on a second type of map data that is used by the second computing process. In some embodiments, the second time may be determined based at least on a second prioritization associated with the second data layer. In some embodiments, the first prioritization and the second prioritization may differ based at least on differences in timing between processing of the first layer data by the first computing process and processing of the second layer data by the second computing process.

In some embodiments, the prioritizations may correspond to a data size of corresponding layer data of one or more of the first data layer or the second data layer. For instance, the first prioritization may correspond to a data size of the first data layer, and/or the second prioritization may correspond to a data size of the second layer data. In some embodiments, a portion of the first layer data and/or the second layer data may be obtained by the first computing process and/or the second computing process. In these and other embodiments, a higher prioritization may be assigned to a layer data of data layer with a larger data size. For instance, the first layer data of the first data layer may be assigned a higher prioritization compared to the second layer data of the second data layer based at least on the first layer data having a larger data size than the second layer data.

In some embodiments, the prioritization may correspond to coverage areas of layer data of the data layers. For instance, the first prioritization may correspond to a first coverage area of the first layer data with respect to information about a first area that corresponds to a first distance from the machine. Additionally or alternatively, the second prioritization may correspond to a second coverage area of the second layer data with respect to information about a second area that corresponds to a second distance from the machine.

In some embodiments, the prioritizations may correspond to an assigned criticality corresponding to computing processes. For instances, the first prioritization may correspond to a first criticality corresponding to the first computing process, and the second prioritization may correspond to a second criticality corresponding to the second computing process. In some embodiments, the criticality of the computing processes may be determined based at least on how essential the operations of the computing processes are for the machine.

In some embodiments, the second computing process may be configured to obtain the second data layer of map data corresponding to the second zone of interest, such as described in the present disclosure for example with respect to FIG. 1.

For instance, the second data layer of map data may include a subset of the map data (e.g., layer data) suitable for determination of lanes and the second computing process may relate to lane determination. In some embodiments, the second data layer may include a subset of the map data that may have certain data formats, such as described in the present disclosure for example with respect to the data layers 115 of FIG. 1.

In some embodiments, the first zone of interest and/or the second zone of interest may be predetermined. For example, the first zone of interest may span across a potential travel route of the machine. In some embodiments, the first zone of interest and/or the second zone of interest may move as the machine moves and/or operates. For example, the second zone of interest may move and/or change as the machine is traveling. For instance, the second zone of interest may include a certain area ahead of and/or around the machine. In some embodiment, the first zone of interest and the second zone of interest may cover different amounts of a geographical area covered by the map data.

In some embodiments, the second data layer of map data may be different from the first data layer. For instance, the first layer and the second layer may include different types of map data. For example, the first data layer and the second data layer may include different subsets of map data suitable for different functions. For instance, the first data layer may include a first subset of map data suitable for route determination, and the second data layer may include a second subset of map data suitable for lane determination.

In some embodiments, the first computing process and the second computing process may obtain the first data layer and the second data layer, respectively, at different times during operation of the machine. For instance, the first computing process and the second computing process may be assigned priorities based at least on type of navigation operations the first computing process and the second computing process are determining. For example, certain operations such as the route determination may be prioritized over other operations such as lane determination. In such instances, the first computing process may be assigned a higher priority than the second computing process. In these and other embodiments, the first computing process may obtain the first data layer prior to the second process obtaining the second data layer of map data. In some embodiments, a portion of the second data layer may be obtained at the same time as the first data layer.

Additionally or alternatively, the first computing process and the second computing process may obtain the corresponding first data layer of map data and the second data layer of map data covering a different amount of area at a time. For instance, certain operations may be configured be processed using more map data than others, geographically. For example, the route determination may be performed using the map data for the entire travel route. Contrastingly, the operations such as the lane determination may be performed using the map data for a smaller portion of the travel route. In these and other embodiments, the first computing process may obtain the first data layer corresponding to the travel route at once, and the second computing process may obtain the second data layer in smaller portions.

In some embodiments, the first computing process and the second computing process may be configured to obtain corresponding layers of map data for one or more tiles. For example, the map data may be divided into one or more tile data sets corresponding to the one or more tiles dividing the area covered by the map data into sub-regions (e.g., tiles). In these and other embodiments, the first computing process and the second computing process may obtain the tile data for the tiles that intersect with the first zone of interest and the second zone of interest, respectively.

Additionally or alternatively, in some embodiments, the first computing process and the second computing process may obtain corresponding layers of map data for one or more segments. For instance, the one or more tiles may be divided into one or more segments. The segments may include corresponding data segments that include the map data for specific areas covered by the segments. In these and other embodiments, the first computing process and the second computing process may obtain first data layer of data segments and the second data layer of data segments for the segments intersecting with the first zone of interest and the second zone of interest, respectively.

At block 306, one or more navigation operations may be caused to be performed using the machine based at least on the first operations by the first computing process based at least on the first data layer, and second operations performed by the second computing process based at least on the second data layer.

For example, the machine may be caused to travel following the travel route determined by the first computing process using the first data layer of map data. Additionally or alternatively, the navigation operations may cause the machine to switch lanes based on the lane determination performed by the second computing process using the second data layer of map data.

In some embodiments, the machine may perform any other navigation operations determined by additional computing processes. For example, a third computing process may be configured to determine a location of the machine in context of a geographical areas surrounding the machine. The third computing process may obtain at least a third layer of map data for use by the third computing process. The third data layer may be based at least on a third type of map data that is used by the third computing system. For example, the third layer may include map data related to a local image data and/or a local RADAR data.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more CPU(s), system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, and/or to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems sensor(s) 458 (e.g., Global Positioning System sensor(s)), RADAR sensor(s) 460, ultrasonic sensor(s) 462, LiDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) 446 (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the HD map 422 of FIG. 4C), location data (e.g., the location of the vehicle 400, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424, which may use one or more wireless antenna(s) 426 and/or modem(s) to communicate over one or more networks. For example, the network interface 424 may be capable of communication over LTE, WCDMA, UMTS, GSM, CDMA2000, etc. The wireless antenna(s) 426 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red, blue, green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward-facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may any number of wide-view cameras 470 on the vehicle 400. In addition, long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

One or more stereo cameras 468 may also be included in a front-facing configuration. The stereo camera(s) 468 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360-degree camera(s), and/or the like. For example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround-view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C is illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400 and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting, and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected to both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 404 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LiDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe-stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LiDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always-on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428, which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPD (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data, in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surrounding at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LiDAR sensor(s) 464. The LiDAR sensor(s) 464 may be used for object and pedestrian detection, emergency braking, collision avoidance, and/or other functions. The LiDAR sensor(s) 464 may be functional safety level ASIL B. In some examples, the vehicle 400 may include multiple LiDAR sensors 464 (e.g., two, four, six, etc.) that may use Ethernet (e.g., to provide data to a Gigabit Ethernet switch).

In some examples, the LiDAR sensor(s) 464 may be capable of providing a list of objects and their distances for a 360-degree field of view. Commercially available LiDAR sensor(s) 464 may have an advertised range of approximately 100 m, with an accuracy of 2 cm-3 cm, and with support for a 100 Mbps Ethernet connection, for example. In some examples, one or more non-protruding LiDAR sensors 464 may be used. In such examples, the LiDAR sensor(s) 464 may be implemented as a small device that may be embedded into the front, rear, sides, and/or corners of the vehicle 400. The LiDAR sensor(s) 464, in such examples, may provide up to a 120-degree horizontal and 35-degree vertical field-of-view, with a 200 m range even for low-reflectivity objects. Front-mounted LiDAR sensor(s) 464 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 400. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LiDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 400), while the 12V communication concept provides information about traffic further ahead. CACC systems may include either or both I2V and V2V information sources. Given the information of the vehicles ahead of the vehicle 400, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network that is trained and thus reduces the risk of false positives, as described herein.

The vehicle 400 may further include the infotainment SoC 430 (e.g., an in-vehicle infotainment system (IVI)). Although illustrated and described as an SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 400. For example, the infotainment SoC 430 may include radios, disk players, navigation systems, video players, USB and Bluetooth connectivity, carputers, in-car entertainment, Wi-Fi, steering wheel audio controls, hands-free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe-stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, include wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 632, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 600. In at least one embodiment, trained or deployed machine learning models corresponding to one or more neural networks may be used to infer or predict information using resources described in the present disclosure with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
a data storage having map data corresponding to a map stored thereon, the map data being organized according to a plurality of data layers based at least on different types of map data used by a plurality of processes of a processing system of a machine, the plurality of processes configured to perform one or more operations associated with a navigation system; and
a computing system to cause communication of one or more individual data layers to the processing system based at least on one or more individual prioritizations associated with the one or more individual data layers, the individual prioritizations being based at least on a timing of processing of the individual data layers by one or more processes of the plurality of processes that are respectively associated with the individual data layers process.

2. The system of claim 1, wherein at least one of the one or more individual prioritizations corresponds to a data size of corresponding layer data of the one or more individual data layers that is to be communicated to the processing system.

3. The system of claim 2, wherein a higher prioritization is assigned to first layer data of a first data layer of the one or more individual data layers as compared to second layer data of a second data layer of the one or more individual data layers based at least on the first layer data having a larger data size than the second layer data.

4. The system of claim 1, wherein at least one of the one or more individual prioritizations corresponds to an assigned criticality corresponding to at least one of the one or more processes corresponding to at least one of the one or more individual data layers.

5. The system of claim 1, wherein at least one of the one or more individual prioritizations corresponds to coverage of corresponding layer data of the one or more individual data layers that is to be communicated to the processing system, the coverage of the corresponding layer data being with respect to information about one or more areas that correspond to one or more individual distances from the machine.

6. The system of claim 1, wherein the plurality of processes performs operations related to one or more of: route determination, lane determination, or localization.

7. The system of claim 1, wherein the map data is organized into a plurality of tile data sets that individually correspond to respective tiles of the map and wherein one or more of the tile data sets of the plurality of tile data sets are organized according to one or more data layers of the plurality of data layers,
wherein at least one of the tile data sets of the plurality of tile data sets is divided into one or more data segments that individually correspond to respective segments of the respective tiles corresponding to the at least one of the tile data sets, and wherein the one or more data segments include at least a portion of data included in the one or more data layers.

8. The system of claim 7, wherein the respective segments include sub-regions of the respective tiles.

9. A method comprising:
obtaining, at a first time, first layer data of a first data layer of map data for use by a first computing process corresponding to navigation of a machine, the first data layer being based at least on a first type of map data that is used by the first computing process, the first time being based at least on a first prioritization associated with the first data layer;
obtaining, at a second time, second layer data of a second data layer of map data for use by a second computing process corresponding to navigation of the machine, the second data layer being based at least on a second type of map data that is used by the second computing process, the second time being based at least on a second prioritization associated with the second data layer;
and
causing one or more navigation operations to be performed by the machine based at least on:
one or more first operations performed by the first computing process based at least on the first data layer; and
one or more second operations performed by the second computing process based at least on the second data layer.

10. The method of claim 9, wherein the first prioritization and the second prioritization differ based at least on differences in timing between processing of the first layer data by the first computing process and processing of the second layer data by the second computing process.

11. The method of claim 9, wherein the first data layer of map data corresponds to a first zone of interest in relation to a location of the machine and the second computing process corresponds to a second zone of interest in relation to the location of the machine.

12. The method of claim 11, wherein the first zone of interest and the second zone of interest cover different amounts of a geographical area.

13. The method of claim 12, wherein at least one of the first zone of interest or the second zone of interest includes an area around the machine.

14. The method of claim 9, wherein one or more of:
the first prioritization corresponds to a data size of the first layer data; or
the second prioritization corresponds to a data size of the second layer data.

15. The method of claim 9, wherein the first prioritization is higher than the second prioritization based at least on the first layer data having a larger data size than the second layer data.

16. The method of claim 9, wherein one or more of:
the first prioritization corresponds to a first coverage area of the first layer data with respect to information about a first area that corresponds to a first distance from the machine; or
the second prioritization corresponds to a second coverage area of the second layer data with respect to information about a second area that corresponds to a second distance from the machine.

17. The method of claim 9, wherein one or more of:
the first prioritization corresponds to a first criticality corresponding to the first computing process; or
the second prioritization corresponds to a second criticality corresponding to the second computing process.

18. A system comprising:
one or more processing units to perform operations comprising:
obtaining, at a first time, first layer data of a first data layer of map data for use by a first computing process corresponding to navigation of a machine, the first data layer being based at least on a first type of map data that is used by the first computing process, the first time being based at least on a first prioritization associated with the first data layer;
obtaining, at a second time, second layer data of a second data layer of map data for use by a second computing process corresponding to navigation of the machine, the second data layer being based at least on a second type of map data that is used by the second computing process, the second time being based at least on a second prioritization associated with the second data layer; and
causing one or more navigation operations to be performed by the machine based at least on:
one or more first operations performed by the first computing process based at least on the first data layer; and
one or more second operations performed by the second computing process based at least on the second data layer.

19. The system of claim 18, wherein the first prioritization and the second prioritization differ based at least on differences in timing between processing of the first layer data by the first computing process and processing of the second layer data by the second computing process.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
